(19) United States
(12) Patent Application Publication
(10) Pub. No.: US 2019/0059008 A1
(43) Pub. Date: Feb. 21, 2019

(54) DATA INTELLIGENCE IN FAULT DETECTION IN A WIRELESS COMMUNICATION NETWORK

(71) Applicant: T-Mobile USA, Inc., Bellevue, WA (US)

(72) Inventor: Chunming Liu, Sammamish, WA (US)

(21) Appl. No.: 15/681,132

(22) Filed: Aug. 18, 2017

(51) Int. Cl. H04W 24/04; H04L 12/24; G06N 5/02

(52) U.S. Cl. CPC H04W 24/04; H04W 24/08; G06N 5/02; H04L 41/0631

(57) ABSTRACT

A wireless communication network provides various services to its subscribers. Techniques and architecture described herein allow performance measuring and monitoring of the wireless communication network and developing a prediction model for predicting causes of faults within the wireless communication network. Such techniques allow for gathering of key performance indicator (KPI) performance measurements between points within the wireless communication network. The performance measurements can include evaluating nodes, links, subnetworks, etc., within the wireless communication network. Based upon the performance measurements and historical data, a prediction model can be developed that can be used to predict a likely possible cause of a future fault within the wireless communication network.

### BACKGROUND

In recent years, telecommunication devices have advanced from offering simple voice calling services within wireless communication networks to providing users with many new features. Telecommunication devices now provide messaging services such as email, text messaging, and instant messaging; data services such as Internet browsing; media services such as storing and playing a library of favorite songs; location services; and many others. Thus, telecommunication devices, referred to herein as user devices or mobile devices, are often used in multiple contexts. In addition to the new features provided by the telecommunication devices, users of such telecommunication devices have greatly increased. Such an increase in users is only expected to continue and in fact, it is expected that there could be a growth rate of twenty times more users in the next few years alone.

Wireless communication networks are generally made up of multiple nodes, links, subnetworks, etc. Services, e.g., telephone calls, data transmission, etc., provided to users of the wireless communication network travel between the various nodes and over various links, other nodes, subnetworks, etc. When faults occur within the wireless communication network, it can be difficult to ascertain what is causing the fault. For example, it can be difficult to ascertain if it is a link, a node, a subnetwork, etc., causing the problem. This difficulty can result in delays in fixing the fault, thereby reducing the experience and satisfaction of users of services within the wireless communication network. Such a delay in fixing the fault can also result in wasted resources in attempting to ascertain and fix the fault, as well as wasting resources of users attempting to utilize services within the wireless communication network.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIGS. 1A and 1B schematically illustrate a wireless communication network, in accordance with various embodiments.

FIGS. 2-4 schematically illustrate topology scenarios of performance measurement paths within the wireless communication network of FIGS. 1A and 1B, in accordance with various embodiments.

FIG. 5 is a flowchart illustrating an example method of creating a statistical model for predicting faults within the wireless communication network of FIGS. 1A and 1B, in accordance with various embodiments.

FIG. 6 schematically illustrates an example of determining the accuracy of the prediction model, in accordance with various embodiments.

FIG. 7 illustrates a component level view of a server configured for use in the arrangement of FIGS. 1A and 1B to provide various services of the wireless communication network of FIGS. 1A and 1B, as well as perform various functions described herein.

### DETAILED DESCRIPTION

Described herein are techniques and architecture that allow for performance measuring and monitoring of a wireless communication network and developing a prediction model for predicting causes of faults within the wireless communication network. Such techniques allow for gathering of key performance indicator (KPI) performance measurements between points within the wireless communication network. The performance measurements can include evaluating nodes, links, subnetworks, etc., within the wireless communication network. Based upon the performance measurements and historical data, a prediction model can be developed that can be used to predict a likely cause of a future fault within the wireless communication network. Thus, the determination and correction of faults within the wireless communication network can be improved and handled in a more efficient and timely manner. This can save resources within the wireless communication network, e.g., processor time, engineer/technician time, etc., as well as resources of users of the wireless communication network attempting to obtain services within the wireless communication network.

In configurations, point-to-point and point-to-multiple point KPI performance measurements and monitoring among various nodes can be performed within a wireless communication network. The wireless communication network may include various nodes, including, for example, business and engineering functional nodes, including a core network, transport, radio network, small cell nodes, data centers, call centers, regional business offices, retail stores, etc. Performance measurement data may be gathered and correlations among various point-to-point and point-to-multiple point routes within the wireless communication network may be determined.

A prediction model based upon the performance measurement data correlations may be determined. The prediction model may then be verified utilizing historical fault data based upon network root cause fix history, e.g., the history of determining the root cause of faults and fixing the faults within the wireless communication network. In verifying the prediction model, an accuracy may be determined based upon historical performance measurement data and network root cause fix history. In configurations, if the accuracy exceeds a predetermined threshold, then the prediction model may be utilized to predict potential causes of faults within the wireless communication network to thereby increase efficiency and speed of addressing faults within the wireless communication network.

More particularly, in configurations, Ethernet virtual circuits (EVCs) between a mobile switch office (MSO) and a cellular cell site may be measured for various KPI performance measurements including, for example, delay, jitter and frame loss ratio. Bandwidth utilization data from cellular site routers can also be gathered. By considering different locations of cellular sites and some cellular sites proximity, performance measurement data may help identify network performance in vendor core networks or EDGE networks since proximity sites generally share the same EDGE network pipe. This can help determine which vendor services are best by comparing performance measurement data during the same period. The performance measurement data can also be utilized in evaluating vendors that provide network services such as multiple class of service (COS). The performance measurement data can be utilized to determine which vendors to utilize in the wireless communication network. As is known, EDGE generally refers to “enhanced data rates for GSM evolution.” An EDGE device is generally referred to a device that provides an entry point into enterprise or service provider core networks. Examples include, for example, routers, routing switches, integrated access devices (IADs), multiplexors and a variety of metropolitan area network (MAN) and wide area network (WAN) access devices. EDGE devices also provide connections into carrier and service provider networks.

Based on historical performance measurement data and outage (fault) events, a prediction model that uses historical data to train the prediction model with KPI performance measurement data to identify how the faults occurred can be developed. Partial performance measurement data may be used as test data to verify the prediction model. Then with the verified model, the prediction model can be used to forecast the probability of a cause for a fault or outage in the core or transport network.

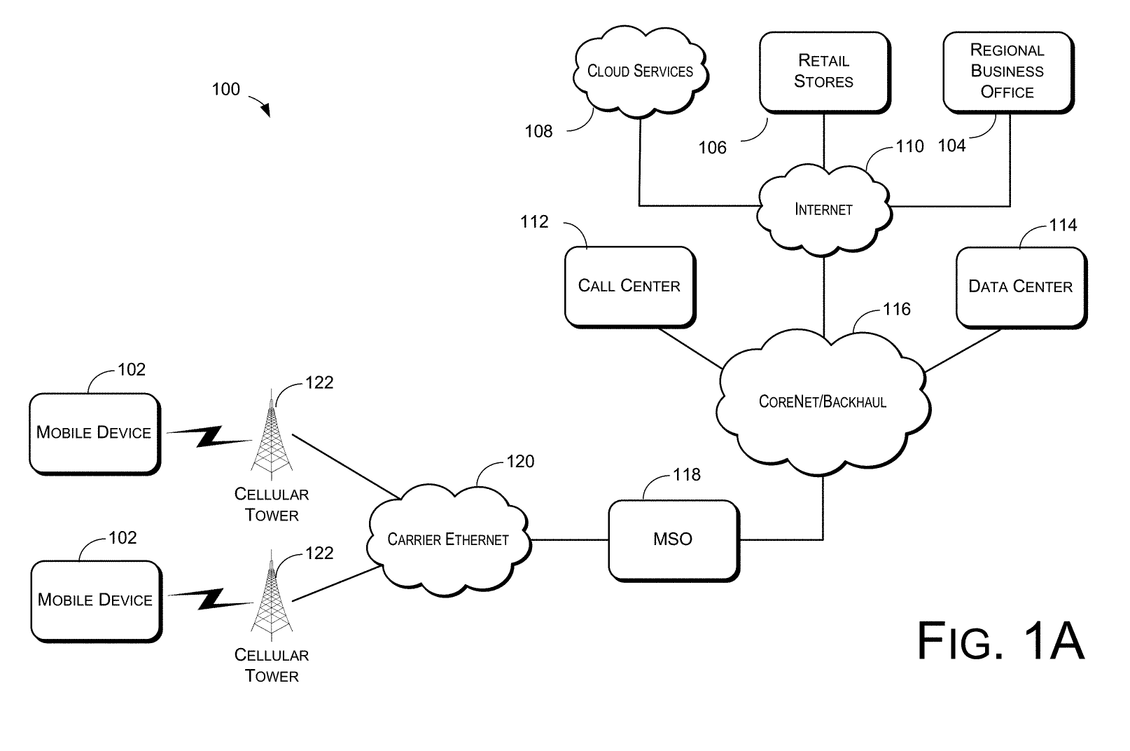

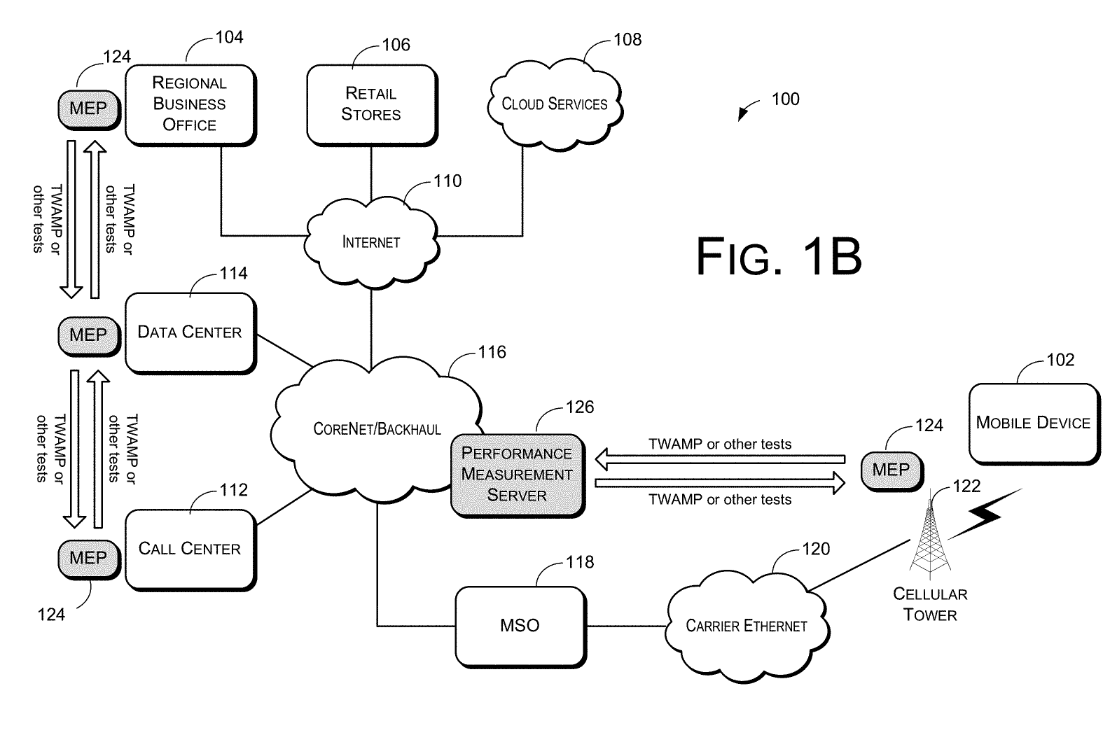

FIG. 1A schematically illustrates an example of a wireless communication network 100 (also referred to herein as Network 100) that may be accessed by mobile devices 102 (which may not necessarily be mobile). As can be seen, in configurations, the wireless communication network 100 includes multiple nodes and networks. The multiple nodes and networks may include one or more of, for example, a regional business office 104, one or more retail stores 106, cloud services 108, the Internet 110, a call center 112, a data center 114, a core net/backhaul network 116, a mobile switch office (MSO) 118, and a carrier Ethernet 120. The wireless communication network 100 may include other nodes and/or networks not specifically mentioned, or may include fewer nodes and/or networks than specifically mentioned.

Access points such as, for example, cellular towers 122, can be utilized to provide access to the wireless communication network 100 for mobile devices 102. In configurations, the wireless communication network 100 may represent a regional or subnetwork of an overall larger wireless communication network. Thus, a larger wireless communication network may be made up of multiple networks similar to wireless communication network 100 and thus, the nodes and networks illustrated in FIG. 1A may be replicated within the larger wireless communication network.

In configurations, the mobile devices 102 may comprise any appropriate devices for communicating over a wireless communication network. Such devices include mobile telephones, cellular telephones, mobile computers, Personal Digital Assistants (PDAs), radio frequency devices, handheld computers, laptop computers, tablet computers, palmtops, pagers, as well as desktop computers, devices configured as Internet of Things (IoT) devices, integrated devices combining one or more of the preceding devices, and/or the like. As such, the mobile devices 102 may range widely in terms of capabilities and features. For example, one of the mobile devices 102 may have a numeric keypad, a capability to display only a few lines of text and be configured to interoperate with only GSM networks. However, another of the mobile devices 102 (e.g., a smart phone) may have a touch-sensitive screen, a stylus, an embedded GPS receiver, and a relatively high-resolution display, and be configured to interoperate with multiple types of networks. The mobile devices may also include SIM-less devices (i.e., mobile devices that do not contain a functional subscriber identity module (“SIM”)), roaming mobile devices (i.e., mobile devices operating outside of their home access networks), and/or mobile software applications.

In configurations, the wireless communication network 100 may be configured as one of many types of networks and thus may communicate with the mobile devices 102 using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like. In embodiments, as previously noted, the wireless communication network 100 may be include an IMS 100a and thus, may provide various services such as, for example, voice over long term evolution (VoLTE) service, video over long term evolution (ViLTE) service, rich communication services (RCS) and/or web real time communication (Web RTC).

FIG. 1B schematically illustrates the wireless communication network 100 of FIG. 1A that includes a mesh performance measurement network. In configurations, the performance measurement may be based upon a two-way active measurement protocol (TWAMP). TWAMP tests or other tests may be utilized to provide point-to-point and point-to-multiple point mesh performance measurement (PM) data within the wireless communication network 100. The PM data thus relates to PM data in point-to-point paths and point-to-multiple point paths, referred to herein as PM paths. The points may represent any of the nodes and networks previously mentioned, as well as links within the wireless communication network 100. As an example, KPI measurements may include delay, jitter, frame loss ratio, connection failure, congestion, Quality of Service (QoS) (e.g., voice, data, etc.) and availability. The tests may include triggering a test of sending a packet from one point to another point, e.g., the data center 114 to the call center 112, and then returning the packet back from the call center 112 to the data center 114. The receiving point generally adds a time stamp to the packet before returning the packet to the original sending point.

In configurations, network devices work as maintenance entity points (MEP) 124 and support PM protocols such as, for example, the TWAMP protocol for testing among various nodes and/or networks of the wireless communication network 100. The testing can involve server-to-client PM or peer-to-peer PM models. A PM server 126 may be included that implements alternate access vendor (AAV) PMs for the mobile backhaul 116, PMs from the data center 114 to the call center(s) 112, PMs from the data center 114 to retail stores 106, etc., as illustrated in FIG. 1B.

As PM data is gathered based on the TWAMP tests (or other tests), the PM data can be correlated and analyzed. For each PM path, it is assumed that there are KPI metrics defined. If the PM data is within a predefined KPI range, then the performance is regarded as good. Otherwise, the performance is regarded as bad. For example, for AAV mobile backhaul, the KPI matrix may be defined as a frame delay having less than 16 milliseconds (roundtrip); jitter less than four milliseconds (roundtrip); frame loss rate less than 1.0E-6; and service availability 99.99 percent.

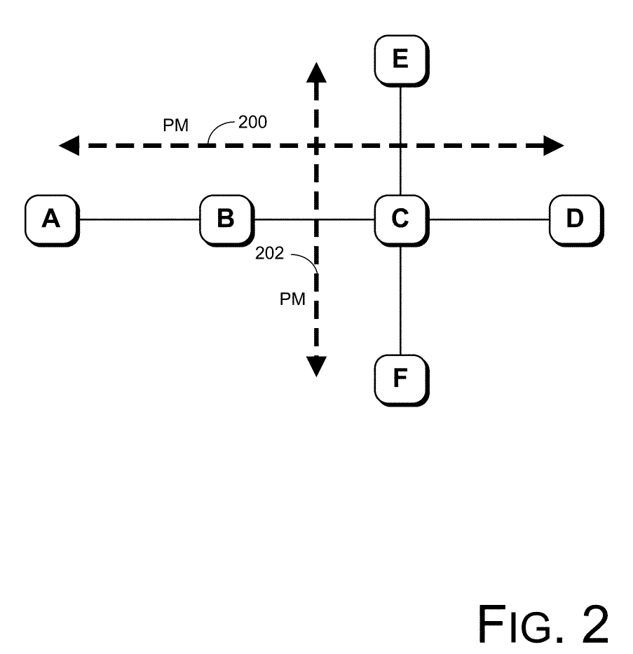

Referring to FIGS. 2-4, PM data correlation based upon topology of the wireless communication network 100 can be described. FIG. 2 schematically illustrates an example scenario where two PM paths 200, 202 share a common node (C) in the middle. Thus, it is assumed that TWAMP tests for the PM paths 200 (A to D) and 202 (E to F) both measure cross node C. As can be seen in Table 1, if the resulting PM data indicates that PM path 200 (AD) is good and PM path 202 (EF) is good, then node C is also good. However, if EF is good and AD is bad, there is a high probability that C is good since the PM data indicates that the connection between E and F is good. Likewise, if AD is good, but EF is bad, then there is a high probability that node C is good since the connection between A and D is good. If both EF is bad and AD is bad, then the status of C is uncertain, but may likely be bad.

TABLE 1

| | {E, F} good | {E, F} bad |
|---|---|---|
| {A, D} good | C good | C is high probability |
| | | good |
| {A, D} bad | C is high probability | C is uncertain |
| | good | |

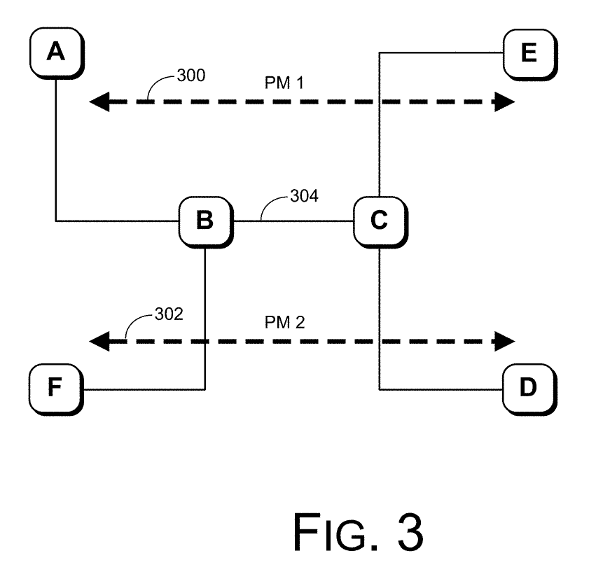

FIG. 3 schematically illustrates a scenario wherein a first PM path 300 (A, E) and a second PM path 302 (F, D) share a common link 304 (B-C in the middle). As can be seen in Table 2, if PM path 300 (A to E) is good and PM path 302 (F to D) is good, then the B to C link is good. If the FD connection is good, but the AE connection is bad, then it is likely that the BC link is good since the AE connection is good. However, if both the AE connection and the FD connection is bad, then it is uncertain whether the BC link is good or bad. However, since both AE and FD are bad, then it may be likely that the BC link is bad and is the cause of the faults.

TABLE 2

| | {F, D} good | {F, D} bad |
|---|---|---|
| {A, E} good | B<->C link good | B<->C link is high |
| | | probability good |
| {A, E} bad | B<->C link is high | B<->C link is uncertain |
| | probability good | |

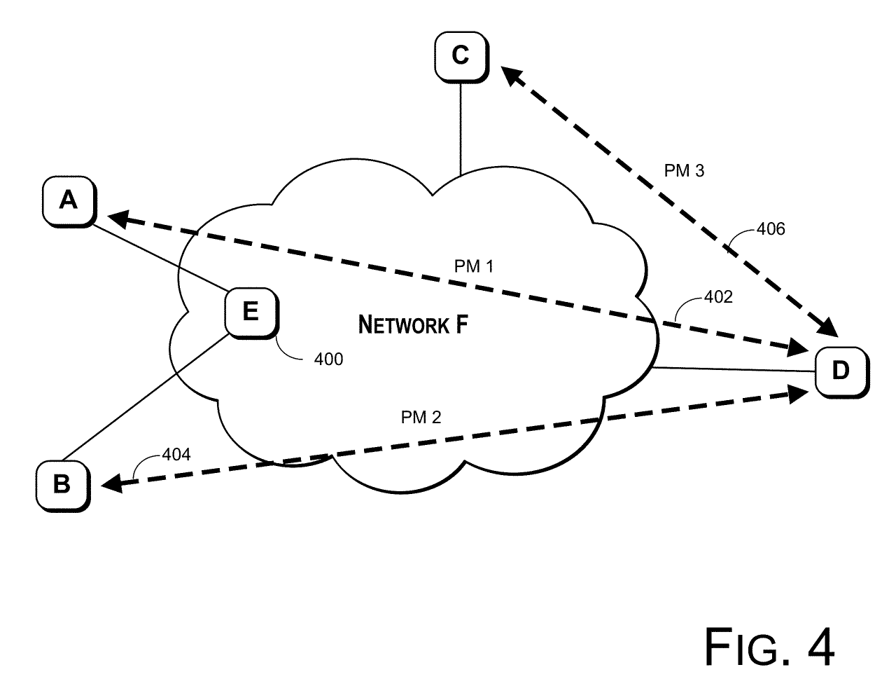

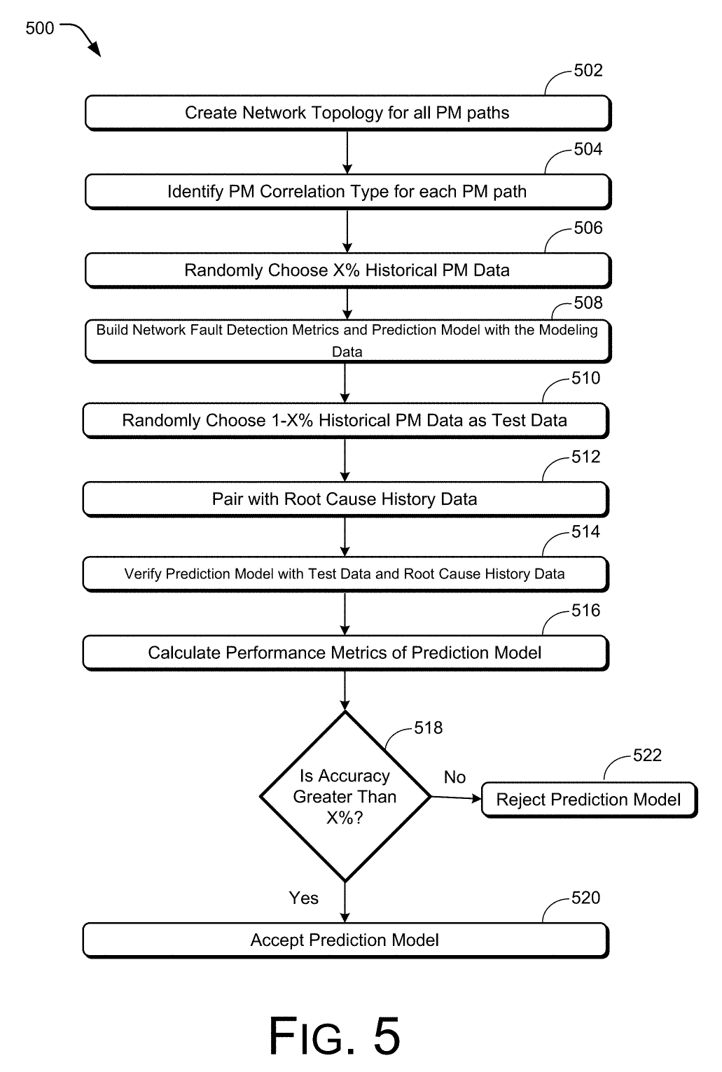

FIG. 4 schematically illustrates a scenario where two PM pairs (AE and FD) share a common network/subnetwork (Network F) in the middle between them. For example, Network F may represent an AAV mobile backhaul that may be implemented as a third party AAV carrier Ethernet network to implement the transport between, for example, the MSO 118 and cellular sites 122. Considering the site location, some sites may share the same AAV provider EDGE device 400 (node E) in the AAV Network F, such as node A and node B in FIG. 4, while other sites may use a different device or subnet of AAV Network F, such as node C in FIG. 5.

Referring to Table 3, if a first PM path 402, a second PM path 404 and a third PM path 406 are all good, then Network F is good. If PM path 402 and PM path 404 are good, but PM path 406 is bad, then the subnet with AAV provider EDGE device 400 (node E) is good and Network F is at least partially good. If PM path 402 and PM path 406 are good, but PM path 404 is bad, then Network F is good. Node B may be bad or the link between node B and node E may be bad. If PM path 404 and PM path 406 are good but PM path 402 is bad, then Network F is good and node A may be bad or the link between node A and node E may be bad. If PM path 406 is good but PM path 402 and PM path 404 are bad, then Network F is good and AAV provider EDGE device 400 (node E) is bad. If PM path 404 is good but PM path 402 and PM path 406 are bad, then Network F is partially good and the link between node A and node E is bad. If PM path 402 is good but PM path 404 and PM path 406 are bad, then Network F is partially good and the link between node B and node E is bad. If PM oath 402, PM path 404 and PM path 406 3 are all bad, then Network F is bad.

TABLE 3

| PM Results | |
|---|---|
| PM1, PM2, PM3 good | Network F good |
| PM1, PM2 good, PM3 bad | Subnet with PE E is good, |
| | partial network F good |
| PM1, PM3 good, PM2 bad | network F good, Node B is |
| | bad or link between B and E is |
| | bad |
| PM2, PM3 good, PM1 bad | network F good, Node A is |
| | bad or link between A and E |
| | is bad |
| PM3 good, PM1 and PM2 | network F good, PE E is bad |
| bad | |
| PM2 good, PM1 and PM3 | Network F partial good. The |
| bad | link between A and E is bad |
| PM1 good, PM2 and PM3 | Network F partial good. The |
| bad | link between B and E is bad |
| PM1, PM2, PM3 all bad | Network F bad |

Thus, in accordance with configurations, the various connections illustrated among the various nodes in FIGS. 1A and 1B may have topologies defined as described with reference to FIGS. 2-4. The network topology is created for all potential performance measurement (PM) paths within the wireless communication network 100 of FIGS. 1A and 1B. Tests, such as, for example, TWAMP tests, may be sent along the topology paths as previously mentioned to create and gather data. For example, the PM data may determine faults or problems in response to tests that occur along PM paths and what likely caused the faults based upon the topology and correlations. The data may be analyzed in order to determine numbers and/or percentages of the likely causes for various faults based upon the tests.

In configurations, referring to FIG. 5, an example method 500 for creating a statistical model for predicting faults within the wireless communication network 100 may be created based upon PM data as described herein, as well as root cause history data, e.g., historical data relating to the causes and fixes of faults within the wireless communication network 100. In configurations, the prediction model may be based upon a regression model, a linear model, a neural network model, etc. These examples of models are simply examples and not meant to be limiting.

At 502, a network topology is created and defined for all PM paths within the wireless communication network 100. At 504, the PM correlation type may be identified for each PM path. For example, two PM paths may correlate based upon a common node, a common link or a common network/subnetwork located “in the middle,” i.e., a shared component along the PM paths.

At 506, a first portion (X %) of historical PM data is randomly chosen as use for modeling and training data. In configurations, the first portion of historical PM data may be chosen in a manner other than random. In a configuration, 60 percent of the historical PM data is randomly chosen. However, in other configurations, the first portion may comprise a range of 60-80 percent of random historical PM data. In configurations, less than 60% of random historical PM data may be chosen. At 508, based upon the modeling and training data, network fault detection metrics are built utilizing the first portion of the historical PM data and the prediction model is created. For example, the fault detection metrics are built based upon faults or failures within the PM data based upon PM tests along the PM paths as described with respect to FIGS. 2-4.

At 510, test data is obtained based upon the remaining portion (1−X %) of the historical PM data to test the prediction model. Thus, if the first portion of the randomly chosen historical data was 60 percent, then the second portion of the randomly chosen historical PM data is 40 percent. In configurations, the second portion of historical PM data may be chosen in a manner other than random. Thus, in configurations, the second portion of the randomly chosen historical data may be in a range of 40-20 percent based upon the amount of the first portion of randomly chosen historical PM data. In configurations, more than 40% of random historical PM data may be chosen. At 512, root cause history data, e.g., history data with respect to the actual root cause and fixes of faults within the wireless communication network is obtained and paired with the test data.

At 514, the prediction model can then be verified using the second portion of randomly chosen historical PM data and the root cause history data. For example, based upon the test data, the prediction model may be utilized to predict the causes of faults within the test data, e.g., the second portion of the historical PM data. Then the root cause history data can be evaluated in order to determine how accurately the prediction model predicted the actual root causes of faults within the test data. For example, if the prediction model predicted that a fault between node A and node B was due to node C on Aug. 1, 2016, then the root cause history can be used to verify that indeed node C caused the fault between node A and Node B. As will be discussed herein, an accuracy of the prediction model may be calculated.

Thus, at 516, performance metrics of the prediction model can be calculated based upon how the prediction model performed with the test data reference to the root cause history. At 518, if the accuracy of the prediction model, based upon the performance metrics, is greater than a predetermined threshold, e.g., 80 percent, 85 percent, 90 percent, etc., then the prediction model is accepted at 520. If not, then the prediction model may be rejected at 522 and the PM data may need to be reanalyzed and reevaluated, or new PM data may need to be obtained.

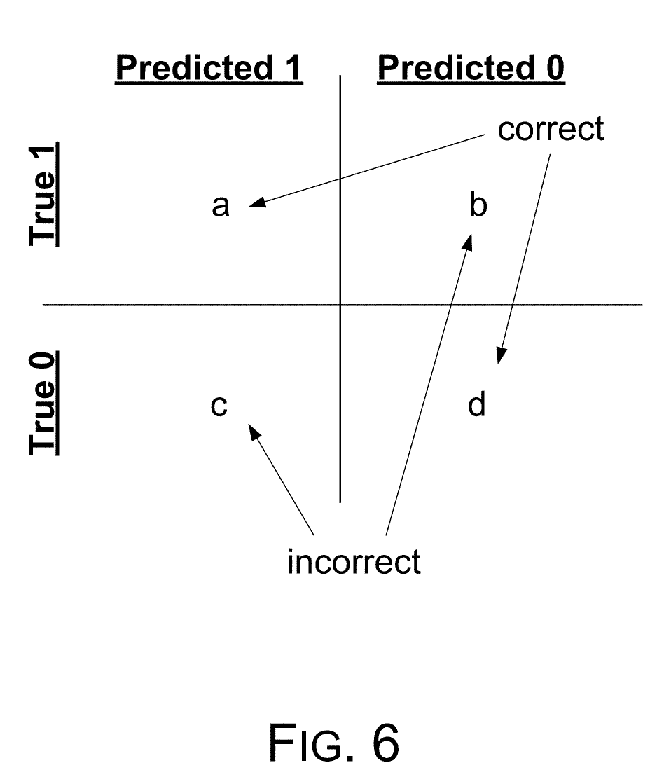

FIG. 6 illustrates an example of determining the accuracy of the prediction model. For example, if a “1” was predicted and in fact, the value is “1,” then “a” represents a correct prediction. If “0” was predicted and the value ends up truly being “0,” then “d” represents a correct prediction. If a “1” or a “0” was predicted, but the true value was instead the opposite, then “b” and “c” represent the incorrect predictions. The accuracy of the prediction model may then be determined by the total number of “a”s and “d”s divided by the total numbers of “a” s, “b” s, “c”s and “d” s, e.g. (a+d)/(a+b+c+d).

Thus, when future faults occur within the wireless communication network 100, the prediction model may be used to predict the likely potential causes of the faults. In configurations, when using the prediction model, data may be obtained based upon predictions using the prediction model based upon PM paths and correlations, and then comparing the predictions with the actual root cause of the faults. This data may then be utilized to update the prediction model to thereby allow the prediction model to continue to learn and evolve.

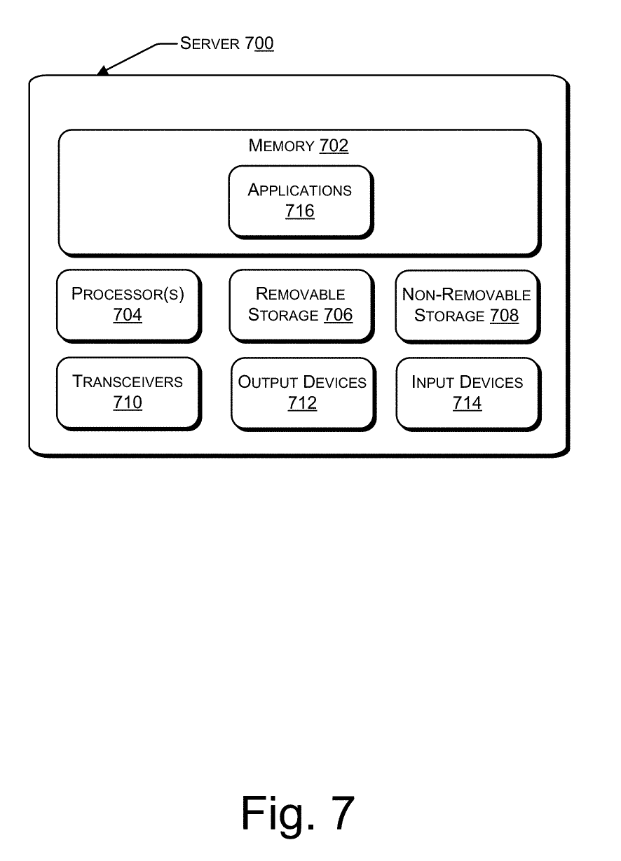

FIG. 7 schematically illustrates a component level view of a server, e.g., a server configured for use as a node for use within a wireless communication network, e.g., wireless communication network 100 and/or PM server 126, in order to provide performance measuring and monitoring of a wireless communication network and developing a prediction model for predicting causes of faults within the wireless communication network, according to the techniques described herein. As illustrated, the server 700 comprises a system memory 702. Also, the server 700 includes processor(s) 704, a removable storage 706, a non-removable storage 708, transceivers 710, output device(s) 712, and input device(s) 714.

In various implementations, system memory 702 is volatile (such as RAM), non-volatile (such as ROM, flash memory, etc.) or some combination of the two. In some implementations, the processor(s) 704 is a central processing unit (CPU), a graphics processing unit (GPU), or both CPU and GPU, or any other sort of processing unit. System memory 702 may also include applications 716 that allow the server to perform various functions.

The server 700 may also include additional data storage devices (removable and/or non-removable) such as, for example, magnetic disks, optical disks, or tape. Such additional storage is illustrated in FIG. 7 by removable storage 706 and non-removable storage 708.

Non-transitory computer-readable media may include volatile and nonvolatile, removable and non-removable tangible, physical media implemented in technology for storage of information, such as computer readable instructions, data structures, program modules, or other data. System memory 702, removable storage 706 and non-removable storage 708 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 700. Any such non-transitory computer-readable media may be part of the server 700.

In some implementations, the transceivers 710 include any sort of transceivers known in the art. For example, the transceivers 710 may include wired communication components, such as an Ethernet port, for communicating with other networked devices. Also or instead, the transceivers 710 may include wireless modem(s) to may facilitate wireless connectivity with other computing devices. Further, the transceivers 710 may include a radio transceiver that performs the function of transmitting and receiving radio frequency communications via an antenna.

In some implementations, the output devices 712 include any sort of output devices known in the art, such as a display (e.g., a liquid crystal display), speakers, a vibrating mechanism, or a tactile feedback mechanism. Output devices 712 also include ports for one or more peripheral devices, such as headphones, peripheral speakers, or a peripheral display.

In various implementations, input devices 714 include any sort of input devices known in the art. For example, input devices 714 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A computer-implemented method comprising:
gathering performance measurement data related to point-to-point performance measurements of a wireless communication network;
determining correlations among at least some of the performance measurements;
based at least in part on the correlations, analyzing a first portion of the performance measurement data;
based at least in part on the analyzing, creating a prediction model for predicting causes of faults within the wireless communication network;
obtaining root cause fix history data related to past faults within the wireless communication network;
based at least in part on the root cause fix history data, verifying the prediction model with a second portion of the performance measurement data; and
applying the prediction model to future faults within the wireless communication network to predict potential causes of the future faults.

2. The computer-implemented method of claim 1, wherein determining correlations among at least some of the performance measurements comprises determining correlations with respect to components between points of the point-to-point performance measurements.

3. The computer-implemented method of claim 2, wherein each component of the components comprises one of (i) a node of the wireless communication network, (ii) a link within the wireless communication network, or (iii) a sub-network within the wireless communication network.

4. The computer-implemented method of claim 1, wherein verifying the prediction model comprises:
based at least in part on the on the root cause fix history data and the second portion of the performance measurement data, calculating performance metrics of the prediction model; and
based at least in part on the performance metrics, determining an accuracy of predictions of the forecast model.

5. The computer-implemented method of claim 4, wherein verifying the prediction model further comprises accepting the prediction model if the accuracy is greater than a predetermined threshold.

6. The computer-implemented method of claim 1, wherein creating the prediction model comprises creating the prediction model based upon one of (i) a regression model, (ii) a linear model, or (iii) a neural network model.

7. The computer-implemented method of claim 1, wherein the first portion of the performance measurement data comprises 60% to 80% of the performance measurement data and the second portion of the performance measurement data comprises 40% to 20% of the performance measurement data.

8. The computer-implemented method of claim 1, further comprising:
determining actual causes of the future faults within the wireless communication network;
determining an accuracy of predicted potential causes of the future faults; and
based at least in part on the accuracy of the predicted causes, updating the prediction model.

9. An apparatus comprising:
a non-transitory storage medium; and
instructions stored in the non-transitory storage medium, the instructions being executable by the apparatus to:
gather performance measurement data related to point-to-point performance measurements of a wireless communication network;
determine correlations among at least some of the performance measurements;
based at least in part on the correlations, analyze a first portion of the performance measurement data;
based at least in part on the analyzing, create a prediction model for predicting causes of faults within the wireless communication network;
obtain root cause fix history data related to past faults within the wireless communication network;
based at least in part on the root cause fix history data, verify the prediction model with a second portion of the performance measurement data; and
apply the prediction model to future faults within the wireless communication network to predict potential causes of the future faults.

10. The apparatus of claim 8, wherein the instructions are further executable by the apparatus to determine correlations with respect to components between points of the point-to-point performance measurements.

11. The apparatus of claim 10, wherein each component of the components comprises one of (i) a node of the wireless communication network, (ii) a link within the wireless communication network, or (iii) a sub-network within the wireless communication network.

12. The apparatus of claim 8, wherein the instructions are further executable by the apparatus to verify the prediction model by:
based at least in part on the on the root cause fix history data and the second portion of the performance measurement data, calculating performance metrics of the prediction model; and
based at least in part on the performance metrics, determining an accuracy of predictions of the forecast model.

13. The apparatus of claim 12, wherein the instructions are further executable by the apparatus to verify the prediction model by:
accepting the prediction model if the accuracy is greater than a predetermined threshold.

14. The apparatus of claim 8, wherein the instructions are further executable by the apparatus to create the prediction model based upon one of (i) a regression model, (ii) a linear model, or (iii) a neural network model.

15. The apparatus of claim 8, wherein the first portion of the performance measurement data comprises 60% to 80% of the performance measurement data and the second portion of the performance measurement data comprises 40% to 20% of the performance measurement data.

16. The apparatus of claim 8, wherein the instructions are further executable by the apparatus to:
determine actual causes of the future faults within the wireless communication network;
determine an accuracy of predicted potential causes of the future faults; and
based at least in part on the accuracy of the predicted causes, update the prediction model.

17. A wireless communication network comprising:
one or more processors;
a non-transitory storage medium; and
instructions stored in the non-transitory storage medium, the instructions being executable by the one or more processors to:
gather performance measurement data related to point-to-point performance measurements of the wireless communication network;
determine correlations among at least some of the performance measurements;
based at least in part on the correlations, analyze a first portion of the performance measurement data;
based at least in part on the analyzing, create a prediction model for predicting causes of faults within the wireless communication network;
obtain root cause fix history data related to past faults within the wireless communication network;
based at least in part on the root cause fix history data, verify the prediction model with a second portion of the performance measurement data; and
apply the prediction model to future faults within the wireless communication network to predict potential causes of the future faults.

18. The wireless communication network of claim 17, wherein the instructions are further executable by the one or more processors to:
determine correlations with respect to components between points of the point-to-point performance measurements,
wherein each component of the components comprises one of (i) a node of the wireless communication network, (ii) a link within the wireless communication network, or (iii) a sub-network within the wireless communication network.

19. The wireless communication network of claim 16, wherein the instructions are further executable by the one or more processors to verify the prediction model by:
based at least in part on the on the root cause fix history data and the second portion of the performance measurement data, calculating performance metrics of the prediction model;
based at least in part on the performance metrics, determining an accuracy of predictions of the forecast model; and
accepting the prediction model if the accuracy is greater than a predetermined threshold.

20. The wireless communication network of claim 17, wherein the instructions are further executable by the one or more processors to:
determine actual causes of the future faults within the wireless communication network;
determine an accuracy of predicted potential causes of the future faults; and
based at least in part on the accuracy of the predicted causes, update the prediction model.
